(19) United States
(12) Patent Application Publication
(10) Pub. No.: US 2021/0158493 A1
(43) Pub. Date: May 27, 2021

(54) GENERATION OF COMPOSITE IMAGES USING INTERMEDIATE IMAGE SURFACES

(71) Applicant: GM GLOBAL TECHNOLOGY OPERATIONS LLC, Detroit, MI (US)

(72) Inventors: Michael Slutsky, Kfar Saba (IL); Yael Gefen, Tel Aviv (IL); Lior Stein, Ramat HaSharon (IL)

(21) Appl. No.: 16/691,198

(22) Filed: Nov. 21, 2019

(51) Int. Cl. G06T 5/00; G06T 5/50

(52) U.S. Cl. CPC G06T 5/006; G06T 5/50; B60R 11/04; G06T 2207/20228; G06T 2207/20221

(57) ABSTRACT

A system for processing images includes a receiving module configured to receive a plurality of images generated by one or more imaging devices, the plurality of images including a first image taken from a first location and orientation, and a second image taken from a second location and orientation. The system also includes an image analysis module configured to generate a composite image on a target image surface based on at least the first image and the second image. The image analysis module is configured to perform steps that include selecting a planar intermediate image surface, projecting the first image and the second image onto the intermediate image surface, combining the projected first image and the projected second image at the intermediate image surface to generate an intermediate image, and projecting the intermediate image onto the target image surface to generate the composite image.

### INTRODUCTION

The subject disclosure relates to the art of image generation and processing, and more particularly, to a system and method for creating composite images using intermediate manifold generation.

Modern vehicles are increasingly equipped with cameras and/or other imaging devices and sensors to facilitate vehicle operation and increase safety. Cameras can be included in a vehicle for various purposes, such as increased visibility and driver awareness, assisting a driver and performing vehicle control functions. Autonomous control of vehicles is becoming more prevalent, and autonomous control systems are equipped with the capability to identify environmental objects and features using cameras and other sensors, such as radar sensors. Some imaging systems attempt to create panoramic surround images to provide a user with a continuous view of a region around a vehicle. Vehicle imaging systems typically take multiple images from different orientations and project the images onto a topological surface referred to as a manifold. This projection typically results in distortions or other image artifacts, which should be corrected or otherwise accounted for to improve the resultant image.

### SUMMARY

In one exemplary embodiment, a system for processing images includes a processing device including a receiving module configured to receive a plurality of images generated by one or more imaging devices, the plurality of images including a first image taken from a first location and orientation, and a second image taken from a second location and orientation. The system also includes an image analysis module configured to generate a composite image on a target image surface based on at least the first image and the second image. The image analysis module is configured to perform steps that include selecting a planar intermediate image surface, projecting the first image and the second image onto the intermediate image surface, combining the projected first image and the projected second image at the intermediate image surface to generate an intermediate image, and projecting the intermediate image onto the target image surface to generate the composite image. The system further includes an output module configured to output the composite image.

In addition to one or more of the features described herein, the intermediate image surface includes at least one planar surface.

In addition to one or more of the features described herein, the intermediate image surface includes a plane that extends from a first location of a first imaging device to a second location of a second imaging device.

In addition to one or more of the features described herein, the first imaging device and the second imaging device are disposed at a vehicle and separated by a selected distance, the first imaging device and the second imaging device having overlapping fields of view.

In addition to one or more of the features described herein, the combining includes stitching the first and second images by combining overlapping regions of the first image and the second image to generate the intermediate image.

In addition to one or more of the features described herein, the first imaging device and the second imaging device have non-linear fields of view, and the projecting onto the intermediate image surface includes performing a spherical projection to rectify the first image and the second image on the intermediate image surface.

In addition to one or more of the features described herein, the projecting onto the intermediate image surface includes calculating one or more image disparities between the first image and the second image, and performing disparity-based stitching of the first image and the second image.

In addition to one or more of the features described herein, the images are taken by one or more cameras disposed on a vehicle, and the target image surface is selected from a ground plane surface and a curved two-dimensional surface at least partially surrounding the vehicle.

In one exemplary embodiment, a method of processing images includes receiving a plurality of images by a receiving module, the plurality of images generated by one or more imaging devices, the plurality of images including a first image taken from a first location and orientation, and a second image taken from a second location and orientation. The method also includes generating, by an image analysis module, a composite image on a target image surface based on at least the first image and the second image. Generating the composite image includes selecting a planar intermediate image surface, projecting the first image and the second image onto the intermediate image surface, combining the projected first image and the projected second image at the intermediate image surface to generate an intermediate image, and projecting the intermediate image onto the target image surface to generate the composite image.

In addition to one or more of the features described herein, the intermediate image surface includes at least one planar surface.

In addition to one or more of the features described herein, the intermediate image surface includes a plane that extends from a first location of a first imaging device to a second location of a second imaging device.

In addition to one or more of the features described herein, the first imaging device and the second imaging device are disposed at a vehicle and separated by a selected distance, the first imaging device and the second imaging device having overlapping fields of view.

In addition to one or more of the features described herein, the combining includes stitching the first and second images by combining overlapping regions of the first image and the second image to generate the intermediate image.

In addition to one or more of the features described herein, the first imaging device and the second imaging device have non-linear fields of view, and the projecting onto the intermediate image surface includes performing a spherical projection to rectify the first image and the second image on the intermediate image surface.

In addition to one or more of the features described herein, the projecting onto the intermediate image surface includes calculating one or more image disparities between the first image and the second image and performing disparity-based stitching of the first image and the second image.

In addition to one or more of the features described herein, the images are taken by one or more cameras disposed on a vehicle, and the target image surface is selected from a ground plane surface and a curved two-dimensional surface at least partially surrounding the vehicle.

In one exemplary embodiment, a vehicle system includes a memory having computer readable instructions and a processing device for executing the computer readable instructions. The computer readable instructions control the processing device to perform steps that include receiving a plurality of images generated by one or more imaging devices, the plurality of images including a first image taken from a first location and orientation, and a second image taken from a second location and orientation, and generating, by an image analysis module, a composite image on a target image surface based on at least the first image and the second image. Generating the composite image includes selecting a planar intermediate image surface, projecting the first image and the second image onto the intermediate image surface, combining the projected first image and the projected second image at the intermediate image surface to generate an intermediate image, and projecting the intermediate image onto the target image surface to generate the composite image.

In addition to one or more of the features described herein, the intermediate image surface includes at least one planar surface.

In addition to one or more of the features described herein, the intermediate image surface includes a plane that extends from a first location of a first imaging device to a second location of a second imaging device.

In addition to one or more of the features described herein, the images are taken by one or more cameras disposed on a vehicle, and the target image surface is selected from a ground plane surface and a curved two-dimensional surface at least partially surrounding the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including aspects of an imaging system, in accordance with an exemplary embodiment;

FIG. 2 depicts a computer system configured to perform aspects of image processing, in accordance with an exemplary embodiment;

FIG. 3 depicts an example of an image projected onto a planar target image surface, and illustrates artifacts that can arise due to projection of the image onto the planar target image surface;

FIG. 4 depicts an example of a curved target image surface that can be utilized by the imaging system of FIG. 1 to generate a composite image, in accordance with an exemplary embodiment;

FIG. 5 is a flow chart depicting aspects of a method of generating a composite image on a target image surface, in accordance with an exemplary embodiment;

FIG. 6 depicts an example of an intermediate image surface that can be utilized by the imaging system of FIG. 1 to generate an intermediate image, in accordance with an exemplary embodiment;

FIGS. 7A and 7B depict an example of acquired images taken by vehicle imaging devices;

FIG. 8 illustrates an example of spherical image rectification of acquired images;

FIG. 9 illustrates an example of disparity-based stitching of images; and

FIG. 10 depicts an example of disparity-based stitching of the acquired images of FIGS. 7A and 7B.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods and systems for image analysis and generation are described herein. An embodiment of an imaging system is configured to acquire images from one or multiple cameras, such as cameras disposed on or in a vehicle. The images are combined and projected onto a target image surface (e.g., a target manifold) to generate a composite image. The target image surface can be, for example, a planar surface in a ground plane or a curved surface that at least partially surrounds the vehicle (e.g., a bowl-shaped surface).

To generate the composite image, images from different cameras (or from different camera orientations in the case of rotating cameras) are projected onto an intermediate image surface (e.g., an intermediate manifold) that is different than the target image surface. In one embodiment, the intermediate image surface includes one or more planar surfaces onto which images are projected. As part of the projection onto the intermediate image, the imaging system may, where desired, perform image processing functions such as stitching and rectification of the acquired images in the intermediate image surface (i.e., the images as projected onto the intermediate image surface).

Embodiments described herein present a number of advantages. The imaging system provides an effective way to process camera images and generate projected composite images that exhibit no artifacts or at least reduced artifacts relative to prior art techniques and systems. For example, modern surround view techniques typically produce image artifacts stemming from large separation between cameras (e.g., comparable to distances from imaged objects). The systems and methods described herein provide an algorithmic approach to generating composite images while alleviating artifacts such as object elimination and ghosting.

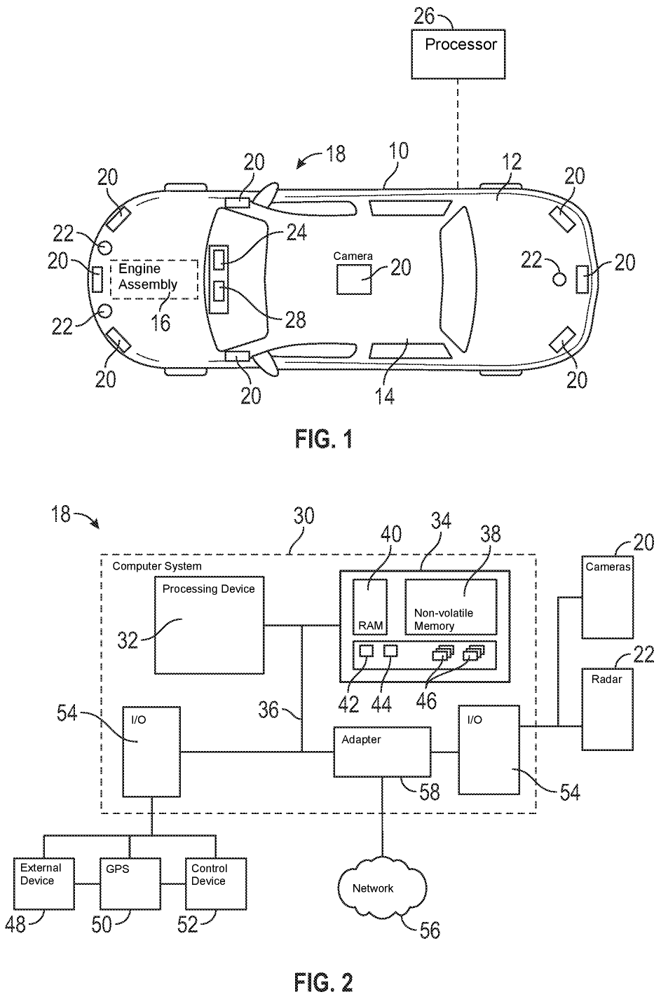

FIG. 1 shows an embodiment of a motor vehicle 10, which includes a vehicle body 12 defining, at least in part, an occupant compartment 14. The vehicle body 12 also supports various vehicle subsystems including an engine assembly 16, and other subsystems to support functions of the engine assembly 16 and other vehicle components, such as a braking subsystem, a steering subsystem, a fuel injection subsystem, an exhaust subsystem and others.

One or more aspects of an imaging system 18 may be incorporated in or connected to the vehicle 10. The imaging system 18 is configured to acquire one or more images from at least one camera and process the one or more images by projecting them onto a target surface, and outputting the projected image as discussed further herein. In one embodiment, the imaging system 18 acquires images from multiple cameras having different locations and/or orientations with respect to the vehicle 10, processes the images and generates a composite image on a target image surface. In this embodiment, the imaging system 18 may perform various image processing functions to reduce or eliminate artifacts such as scale differences, object elimination and ghosting.

In one embodiment, generation of the composite image includes projecting one or more images onto an intermediate image surface (e.g., one or more planes) and processing the one or more images to stitch the images together and/or reduce or eliminate artifacts. As a result of this projection and processing, an intermediate image is created, which is then projected onto a target image surface, such as a curved (e.g., bowl-shaped) or planar (e.g., ground plane) surface.

The imaging system 18 in this embodiment includes one or more optical cameras 20 configured to take images such as color (RGB) images. Images may be still images or video images. For example, the image analysis system 18 is configured to generate panoramic or quasi-panoramic surround images (e.g., images depicting a region around the vehicle 10).

Additional devices or sensors may be included in the imaging system 18. For example, one or more radar assemblies 22 may be included in the vehicle 10. Although the imaging system and methods are described herein in conjunction with optical cameras, they may be utilized to process and generate other types of images, such as infrared, radar and lidar images.

The cameras 20 and/or radar assemblies 22 communicate with one or more processing devices, such as an on-board processing device 24 and/or a remote processor 26, such as a processor in a mapping, vehicle monitoring (e.g., fleet monitoring) or imaging system. The vehicle 10 may also include a user interface system 28 for allowing a user (e.g., a driver or passenger) to input data, view images, and otherwise interact with a processing device and/or the image analysis system 18.

FIG. 2 illustrates aspects of an embodiment of a computer system 30 that is in communication with, or is part of, the imaging system 18, and that can perform various aspects of embodiments described herein. The computer system 30 includes at least one processing device 32, which generally includes one or more processors for performing aspects of image acquisition and analysis methods described herein. The processing device 32 can be integrated into the vehicle 10, for example, as the on-board processor 24, or can be a processing device separate from the vehicle 10, such as a server, a personal computer or a mobile device (e.g., a smartphone or tablet). For example, the processing device 32 can be part of, or in communication with, one or more engine control units (ECU), one or more vehicle control modules, a cloud computing device, a vehicle satellite communication system and/or others. The processing device 32 may be configured to perform image processing methods described herein, and may also perform functions related to control of various vehicle subsystems (e.g., as part of an autonomous or semi-autonomous vehicle control system).

Components of the computer system 30 include the processing device 32 (such as one or more processors or processing units), a system memory 34, and a bus 36 that couples various system components including the system memory 34 to the processing device 32. The system memory 34 may include a variety of computer system readable media. Such media can be any available media that is accessible by the processing device 32, and includes both volatile and non-volatile media, removable and non-removable media.

For example, the system memory 34 includes a non-volatile memory 38 such as a hard drive, and may also include a volatile memory 40, such as random access memory (RAM) and/or cache memory. The computer system 30 can further include other removable/non-removable, volatile/non-volatile computer system storage media.

The system memory 34 can include at least one program product having a set (e.g., at least one) of program modules that are configured to carry out functions of the embodiments described herein. For example, the system memory 34 stores various program modules that generally carry out the functions and/or methodologies of embodiments described herein. A receiving module 42 may be included to perform functions related to acquiring and processing received images and information from cameras, and an image analysis module 44 may be included to perform functions related to image processing as described herein. The system memory 34 may also store various data structures 46, such as data files or other structures that store data related to imaging and image processing. Examples of such data structures include acquired camera models, camera images, intermediate images and composite images. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 32 can also communicate with one or more external devices 48 such as a keyboard, a pointing device, and/or any devices (e.g., network card, modem, etc.) that enable the processing device 32 to communicate with one or more other computing devices. In addition, the processing device 32 can communicate with one or more devices such as the cameras 20 and the radar assemblies 22 used for image analysis. The processing device 32 can also communicate with other devices that may be used in conjunction with the image analysis, such as a Global Positioning System (GPS) device 50 and vehicle control devices or systems 52 (e.g., for driver assist and/or autonomous vehicle control). Communication with various devices can occur via Input/Output (I/O) interfaces 54.

The processing device 32 may also communicate with one or more networks 56 such as a local area network (LAN), a general wide area network (WAN), and/or a public network (e.g., the Internet) via a network adapter 58. It should be understood that although not shown, other hardware and/or software components could be used in conjunction with the computer system 30. Examples include, but are not limited to: microcode, device drivers, redundant processing units, external disk drive arrays, RAID systems, and data archival storage systems, etc.

Modern surround view techniques produce image artifacts stemming from large separation between cameras (comparable to distances from the imaged objects). Such artifacts include object distortion, object elimination and ghosting. The imaging system 18 is configured to generate composite images that are projected onto target surfaces to generate desired views relative to the vehicle 10. Examples of target surfaces include ground plane surfaces and curved surfaces.

The imaging system 18 generates a composite image (e.g., a surround view or surround image) by projecting acquired images onto an intermediate image surface, and combining and processing the projected images on the intermediate image surface to reduce or eliminate image artifacts. The processed and combined images on the intermediate image surface are referred to as an “intermediate image.” Subsequently, the intermediate image is projected onto a target surface.

The intermediate image surfaces and the target image surfaces, in one embodiment, are virtual surfaces referred to as “manifolds.” The various surfaces are referred to hereinafter as image manifolds or simply manifolds; however, it is to be understood that the surfaces may be virtual surfaces or topologies of any form.

Examples of surround views or surround images include top-view images (from a vantage point above the vehicle 10) and bowl-view images. Top-view (or bird's-eye view) surround images are typically generated by taking multiple images (e.g., four images at various orientations) and projecting them on a ground plane. Bowl-view imaging is an attempt to create a view of the vehicle 10 “from the outside,” by emulating the real three-dimensional world of the vehicle surroundings by an image projected on a two-dimensional bowl-like manifold, constructed from the camera imagery. A surround view may be a complete surround view (i.e., encompassing a 360-degree view) or a partial surround view (i.e., encompassing less than 360 degrees),

Projection of images can result in various image artifacts, which distort the original images. For example, when an acquired image is projected onto a ground plane, objects in the ground plane are shown properly, whereas objects above the plane are smeared and distorted. In addition, objects in areas where camera field of views (FOVs) intersect may appear as double objects (referred to as “ghosting”.)

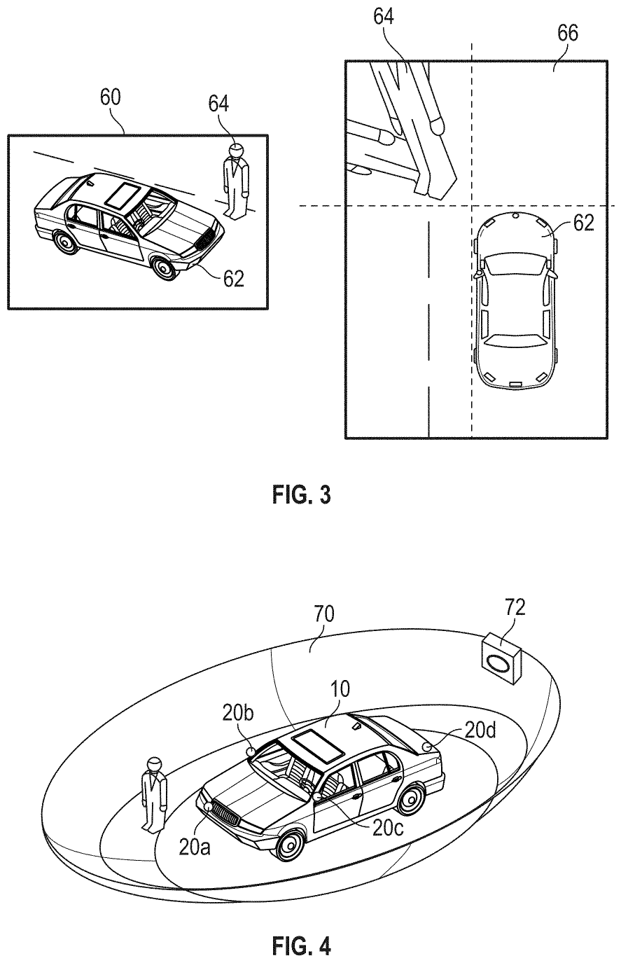

FIG. 3 depicts an example of an original image 60 of a vehicle object 62 and a person object 64 taken by a camera, and a projected image 66 resulting from projection of the original image onto planar manifold located at a ground surface (“ground plane”). As shown, objects in the ground plane are represented properly, but objects above the ground plane are distorted. For example, the feet of the person object 64 and the vehicle object 62 are generally shown properly (are minimally distorted or distorted to an acceptable extent). However, portions of the person object 64 above the ground plane are smeared and distorted. In addition, if multiple images are projected onto the ground plane, objects such as the person object 64 can appear as double images (referred to as “ghosting”)

Artifacts such as distortions and ghosting can also be introduced when projecting an image onto a curved manifold such as a bowl-view manifold. In addition, whether projecting multiple images from different fields of view (FOVs) onto a planar or non-planar manifold, objects in the images from overlapping common FOVs can disappear in the projected image (referred to as “object elimination”). Objects in the common FOV of neighboring cameras often vary in appearance (e.g. scale), which further complicates image stitching. An example of a bowl-view target manifold 70 is shown in FIG. 4. In this example, acquired images are projected onto the target manifold from a selected perspective (e.g., a perspective established by the location of a virtual camera 72).

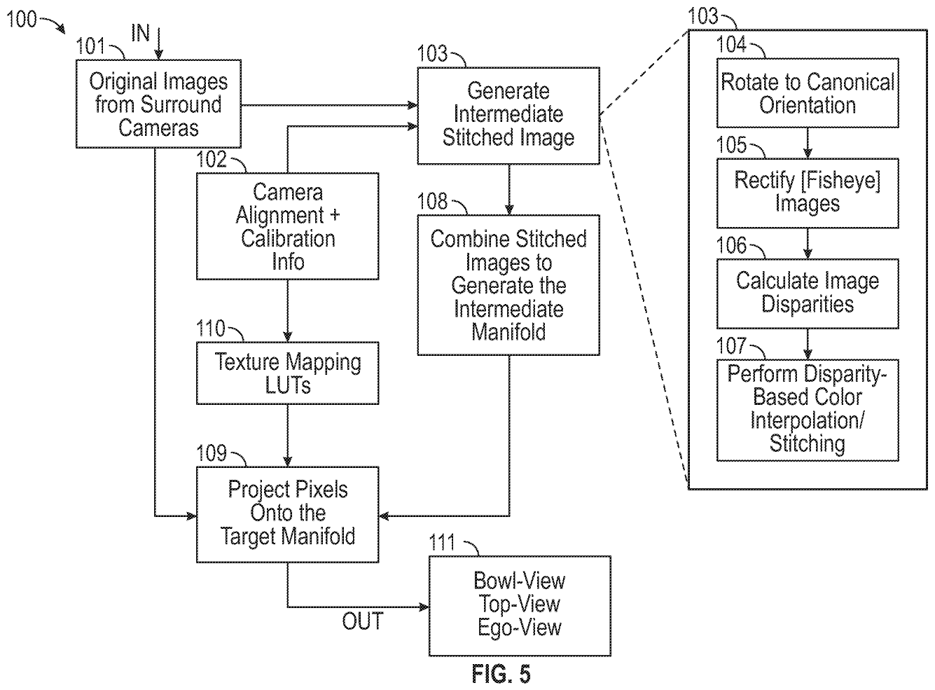

FIG. 5 depicts an embodiment of a method 100 of generating composite images. The imaging system 18, or other processing device or system, may be utilized for performing aspects of the method 100. The method 100 is discussed in conjunction with blocks 101-111. The method 100 is not limited to the number or order of steps therein, as some steps represented by blocks 101-111 may be performed in a different order than that described below, or fewer than all of the steps may be performed.

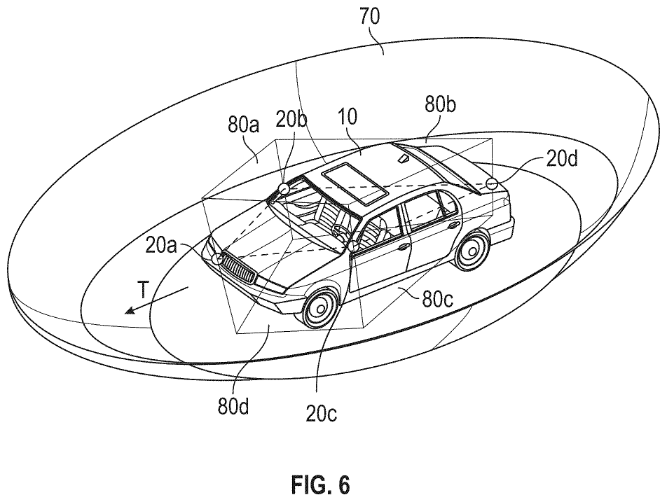

The method 100 is discussed in conjunction with an example of aspects of the imaging system 18 and an example of a target image surface, (i.e., the bowl-shaped target manifold 70), as shown in FIG. 6. In this example, the vehicle 10 includes a front camera 20a having an orientation and FOV facing a direction of travel T, a right-side camera 20b and a left-side camera 20c having respective orientations and FOVs directed laterally with respect to the direction T, and a rear camera 20d having an orientation and FOV directed generally opposite the direction T. The cameras 20a, 20b, 20c and/or 2d may be rotatable or stationary, and neighboring cameras have overlapping FOVs.

Referring again to FIG. 5, at block 101, original images are taken from different orientations and/or locations. The original images may have overlapping FOVs, and may be taken by different cameras. If the original images are taken by a rotating camera, mapping between pixels of two images captured from different orientations of the rotating camera may be described by a depth independent transformation.

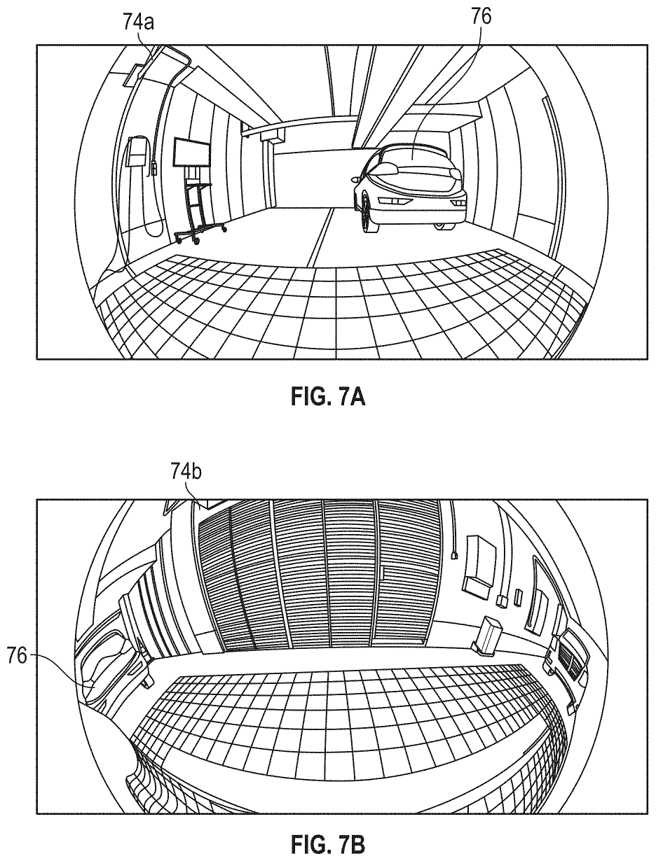

For example, the receiving module 42 receives images taken at the same or a similar time from the cameras. An example of an acquired image set includes an image 74a (shown in FIG. 7A) taken by the front camera 20a, and an image 74b (shown in FIG. 7B) taken by the right-side camera 20b. It can be seen that the images demonstrate strong parallax effects due to the separation of the cameras 20a and 20b (e.g., about 1-3 meters). For example, an object 76 representing a car (the car object 76) is depicted in the images with different scale, position and levels of distortion.

At block 102, camera alignment and calibration information is acquired. Such information may be acquired based on geometric models of each camera.

At block 103, the acquired images, along with the camera alignment and calibration information, are input to a processing device such as the image analysis module 44. The image analysis module 44 generates a combined intermediate image or images (also referred to as a “stitched image”), which in one embodiment is performed by rotating the acquired images to a common alignment, processing the images to remove or reduce artifacts, and stitching the images by blending the overlapping regions of the images.

Blocks 104-107 represent an embodiment of a procedure for generating intermediate images. At block 104, the acquired images are rotated so that they have a common orientation. For example, the images are rotated to a canonical orientation, such as an orientation that faces a desired intermediate manifold.

FIG. 6 depicts an example of intermediate manifolds, which are planar manifolds. In this example, there are four cameras 20a, 20b, 20c and 20d. Four intermediate planar manifolds are selected, so that each intermediate manifold intersects two neighboring cameras. The intermediate manifolds in this example, are denoted as intermediate manifolds 80a, 80b, 80c and 80d.

At block 105, the rotated images are projected via image rectification onto an intermediate manifold. Various image rectification algorithms may be employed, such as planar rectification, cylindrical rectification and polar rectification. In one embodiment, if the cameras are fish-eye cameras, epipolar spherical rectification can be performed to rectify the images.

At block 106, image disparities are calculated, and the rectified images are stitched or otherwise combined based on the disparities (block 107) to generate a combined intermediate image at the intermediate manifold that is free of artifacts such as ghosting and object elimination. An example of an image disparity is shown in FIGS. 7A and 7B, in which the car object 76 is at a different pixel region.

At block 108, if multiple stitched images having the same alignment are present, the multiple stitched images are combined and projected onto the intermediate manifold to generate the intermediate image.

At block 109, the intermediate image is projected onto the target manifold to generate the final composite image. This projection may include texture mapping using look-up tables (LUTs) or other suitable information. In addition, the original acquired images may be used to improve the final image (e.g., confirm that image objects are properly located, and that no objects were eliminated).

At block 110, the final composite image is output to a user, a storage location and/or other processing device or system. For example, the final image can be displayed to a driver using, for example, the interface system 28 or transmitted to an image database, mapping system or vehicle monitoring system.

In one embodiment, the method 100 is used to generate intermediate images for multiple intermediate manifolds. For example, a vehicle may have multiple cameras having various locations and orientations. Intermediate manifolds may be selected as multiple planes to account for the various overlapping images between neighboring cameras. In one embodiment, a number N of planar manifolds is selected to be equal to the number of cameras (N cameras) on the vehicle 10.

If there are multiple intermediate manifolds, the stages represented by blocks 101-108 may be repeated for each intermediate manifold. The resulting intermediate images may then be combined and projected onto the target manifold as a single final composite image.

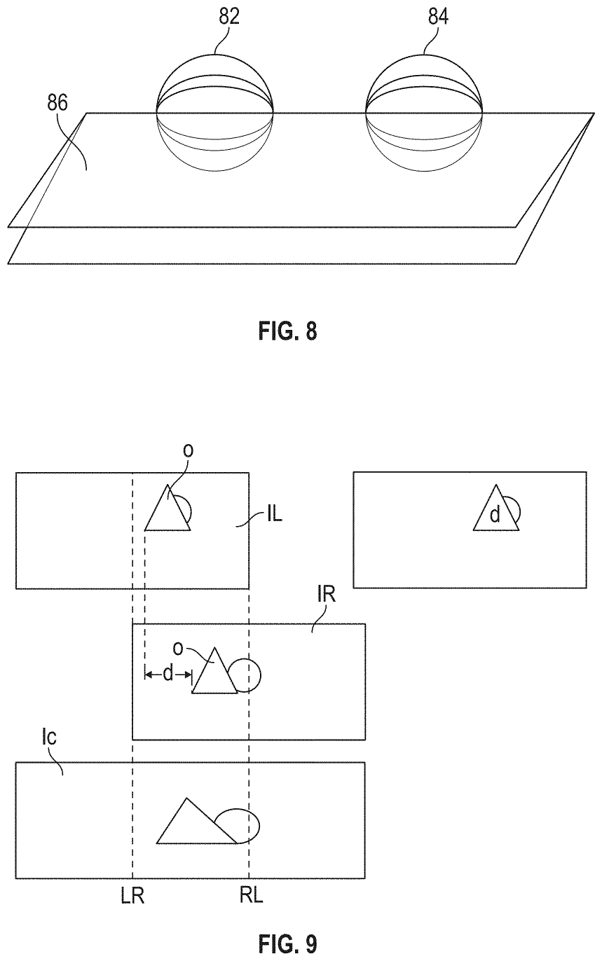

FIG. 8 depicts an example of a rectification process that can be performed as part of the method 100. In this example, acquired images mapped to spherical surfaces 82 and 84 are projected onto a plane 86. The plane may be a selected intermediate manifold such as manifold 80a, 80b, 80c or 80d. Generally, rectifying the images includes resampling the images along lines generated by intersecting the spherical surfaces 82 and 84 with the plane 86. In one embodiment, the rectification has an epipolar constraint, in which the resampling is performed along epipolar lines corresponding to matches between pixels in the acquired images.

FIG. 9 depicts aspects of an example of disparity-based stitching of acquired images. In this example, two images of an object O are taken, where a first image I_{L} is taken from a left-side location and a second image I_{R} is taken from a right-side location.

In this example, there is a disparity din the location of the object O between the left-side image I_{L} and the right-side image I_{R}. The disparity is the pixel distance between a point on the object O in the left-side image I_{L} and the same point on the object in the right-side image I_{R} along an epipolar line.

To generate the combined image, the images are blended using a weighted blending method using the disparity, which is denoted by D in the following equation. For example, pixels are resampled and give a weighted correction value C[i,k] to be applied to each pixel in an object, where i is the row number and k is the column number of a given pixel. The value C[i,k] may be calculated using the following equation:

$$C [ i , k ] = ( \frac{k - LR}{RL - LR} ) {C}_{R} [ i , k - D [ i , k ] ] + ( \frac{RL - k}{RL - LR} ) {C}_{L} [ i , k ] ,$$

where C_{L} is a pixel location on the left-side image, C_{R} is the pixel location on the right-side image, D is the disparity between the objects, LR is a left-side reference location on the blended image I_{C}, and RL is a right-side reference location of the blended image. As can be seen, although some distortion is present, the object is represented as a whole (without doubling or disappearing). It is noted that the above equation can be symmetrized to include an estimation of the disparity starting from a right-hand side of the images (right-to-left or R2L), and an estimation of the disparity starting from a left-hand side of the images (left-to-right or L2R).

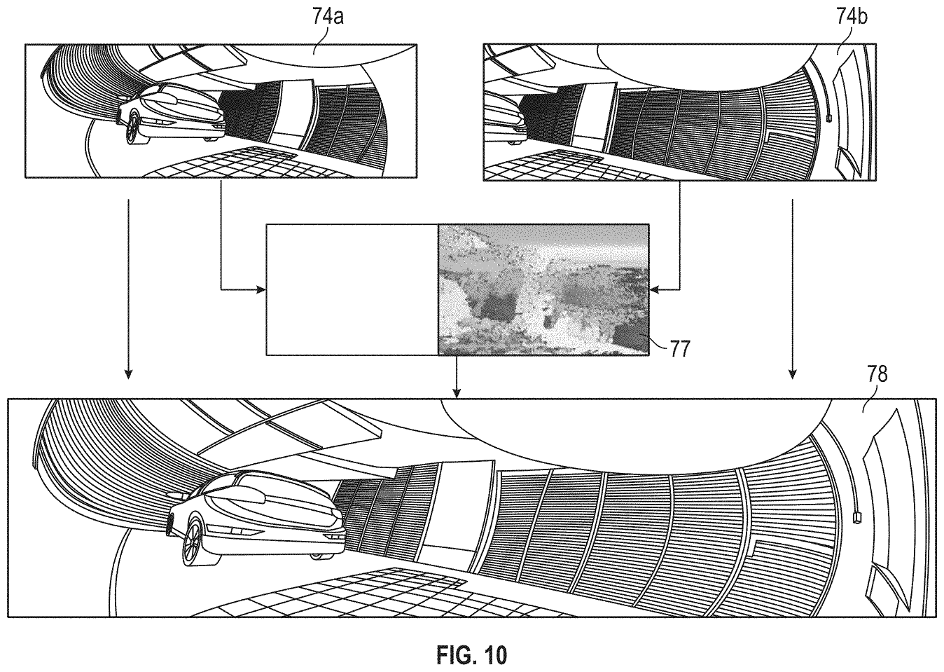

FIG. 10 depicts an example of disparity-based stitching of the images 74a and 74b. In this example, the images are projected onto a parallel plane, and objects in the images are processed to generate a weight map 77 of corrections to be applied to each pixel. The images are blended according to the calculate weights to generate a combined intermediate image 78, which can then be projected onto a target manifold.

Although the embodiments are described in relation to vehicle imaging system, they are not so limited and can be utilized in conjunction with any system or device that acquires and processes camera images. For example, the embodiments may be used in conjunction with security cameras, home monitoring cameras and any other system that incorporates still and/or video imaging.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A system for processing images, comprising:
a processing device including a receiving module configured to receive a plurality of images generated by one or more imaging devices, the plurality of images including a first image taken from a first location and orientation, and a second image taken from a second location and orientation; and
an image analysis module configured to generate a composite image on a target image surface based on at least the first image and the second image, the image analysis module configured to perform:
selecting a planar intermediate image surface, the planar intermediate image surface forming at least one flat plane;
projecting the first image and the second image onto the intermediate image surface, and combining the projected first image and the projected second image at the intermediate image surface to generate an intermediate image;
projecting the intermediate image onto the target image surface to generate the composite image; and
an output module configured to output the composite image.

2. The system of claim 1, wherein the at least one flat plane includes a first flat plane and a second flat plane, and projecting the first image and the second image onto the intermediate image surface includes projecting the first image onto the first flat plane, separately projecting the second image onto the second flat plane, and combining the projected first image and the projected second image to generate the intermediate image.

3. The system of claim 2, wherein the intermediate image surface includes a plane that extends from a first location of a first imaging device to a second location of a second imaging device.

4. The system of claim 3, wherein the first imaging device and the second imaging device are disposed at a vehicle and separated by a selected distance, the first imaging device and the second imaging device having overlapping fields of view.

5. The system of claim 4, wherein the combining includes stitching the first and second images by combining overlapping regions of the first image and the second image to generate the intermediate image.

6. The system of claim 5, wherein the first imaging device and the second imaging device have non-linear fields of view, and the projecting onto the intermediate image surface includes performing a spherical projection to rectify the first image and the second image on the intermediate image surface.

7. The system of claim 6, wherein the projecting onto the intermediate image surface includes calculating one or more image disparities between the first image and the second image, and performing disparity-based stitching of the first image and the second image.

8. The system of claim 1, wherein the images are taken by one or more cameras disposed on a vehicle, and the target image surface is selected from a ground plane surface and a curved two-dimensional surface at least partially surrounding the vehicle.

9. A method of processing images, comprising:
receiving a plurality of images by a receiving module, the plurality of images generated by one or more imaging devices, the plurality of images including a first image taken from a first location and orientation, and a second image taken from a second location and orientation; and
generating, by an image analysis module, a composite image on a target image surface based on at least the first image and the second image, wherein generating the composite image includes:
selecting a planar intermediate image surface, the planar intermediate image surface forming a flat plane;
projecting the first image and the second image onto the intermediate image surface, and combining the projected first image and the projected second image at the intermediate image surface to generate an intermediate image; and
projecting the intermediate image onto the target image surface to generate the composite image.

10. The method of claim 9, wherein the at least one flat plane includes a first flat plane and a second flat plane, and projecting the first image and the second image onto the intermediate image surface includes projecting the first image onto the first flat plane, separately projecting the second image onto the second flat plane, and combining the projected first image and the projected second image to generate the intermediate image.

11. The method of claim 10, wherein the intermediate image surface includes a plane that extends from a first location of a first imaging device to a second location of a second imaging device.

12. The method of claim 11, wherein the first imaging device and the second imaging device are disposed at a vehicle and separated by a selected distance, the first imaging device and the second imaging device having overlapping fields of view.

13. The method of claim 12, wherein the combining includes stitching the first and second images by combining overlapping regions of the first image and the second image to generate the intermediate image.

14. The method of claim 13, wherein the first imaging device and the second imaging device have non-linear fields of view, and the projecting onto the intermediate image surface includes performing a spherical projection to rectify the first image and the second image on the intermediate image surface.

15. The method of claim 14, wherein the projecting onto the intermediate image surface includes calculating one or more image disparities between the first image and the second image, and performing disparity-based stitching of the first image and the second image.

16. The method of claim 9, wherein the images are taken by one or more cameras disposed on a vehicle, and the target image surface is selected from a ground plane surface and a curved two-dimensional surface at least partially surrounding the vehicle.

17. A vehicle system comprising:
a memory having computer readable instructions; and
a processing device for executing the computer readable instructions, the computer readable instructions controlling the processing device to perform:
receiving a plurality of images generated by one or more imaging devices, the plurality of images including a first image taken from a first location and orientation, and a second image taken from a second location and orientation; and
generating, by an image analysis module, a composite image on a target image surface based on at least the first image and the second image, wherein generating the composite image includes:
selecting a planar intermediate image surface, the planar intermediate image surface forming a flat plane;
projecting the first image and the second image onto the intermediate image surface, and combining the projected first image and the projected second image at the intermediate image surface to generate an intermediate image; and
projecting the intermediate image onto the target image surface to generate the composite image.

18. The vehicle system of claim 17, wherein the-at least one flat plane includes a first flat plane and a second flat plane, and projecting the first image and the second image onto the intermediate image surface includes projecting the first image onto the first flat plane, separately projecting the second image onto the second flat plane, and combining the projected first image and the projected second image to generate the intermediate image.

19. The vehicle system of claim 18, wherein the intermediate image surface includes a plane that extends from a first location of a first imaging device to a second location of a second imaging device.

20. The vehicle system of claim 17, wherein the images are taken by one or more cameras disposed on a vehicle, and the target image surface is selected from a ground plane surface and a curved two-dimensional surface at least partially surrounding the vehicle.
